(19) United States
(12) Patent Application Publication
(10) Pub. No.: US 2015/0260939 A1
(43) Pub. Date: Sep. 17, 2015

(54) Lens Module

(71) Applicants: Junjie Yan, Shenzhen (CN); Chuandong Wei, Shenzhen (CN); Chunhuan Fang, Shenzhen (CN); Lei Zhang, shenzhen (CN); Liangwei Wan, Shenzhen (CN)

(72) Inventors: Junjie Yan, Shenzhen (CN); Chuandong Wei, Shenzhen (CN); Chunhuan Fang, Shenzhen (CN); Lei Zhang, shenzhen (CN); Liangwei Wan, Shenzhen (CN)

(73) Assignee: AAC ACOUSTIC TECHNOLOGIES (SHENZHEN) CO. LTD., Shenzhen (CN)

(21) Appl. No.: 14/643,099

(22) Filed: Mar. 10, 2015

(30) Foreign Application Priority Data
Mar. 14, 2014 (CN) 201420123316.5

(51) Int. Cl. G02B 7/02; G02B 7/00

(52) U.S. Cl. CPC G02B 7/021; G02B 7/003

(57) ABSTRACT

Disclosed is lens module. The lens module includes a barrel and a lens group disposed in the barrel. The lens group includes a first lens element connecting with the barrel and a second lens element connecting with the first lens element. The first lens element connecting with the barrel makes the lens module have a first matching precision. The first matching precision makes the barrel and the lens group be concentric. The first lens element has a first arc surface and the second lens element has a second arc surface engaging with the first arc surface which makes the lens module have a second matching precision. The second matching precision makes the first lens element and the second lens element be concentric.

### FIELD OF THE INVENTION

The disclosure described herein relates generally to a lens module.

### DESCRIPTION OF RELATED ART

With the intelligence development of electronic devices, the electronic devices, like cameras, laptops, mobile phones, are all equipped with lens modules. People not only require the electronic devices have various functions, but also require a lens module capable of capturing image with high performance.

Related lens module usually comprises a barrel having a light hole and a lens group having at least two lens elements. Ideally, the optical axis of the lens group and a line passing through the geometrical center of the light hole should coincide with each other, that is, the barrel and the lens group should be concentric. Furthermore, the connection between the lens elements should also be very stable. However, due to the high sensitivity to the eccentricity, the concentricity and stability of the lens elements are hard to be guaranteed.

Therefore, an improved lens module is provided in the present disclosure to solve the problem mentioned above.

### BRIEF DESCRIPTION OF THE DRAWINGS

FIG. 1 illustrates a cross-sectional view of a lens module according to a first exemplary embodiment of the present disclosure.

FIG. 2 illustrates a cross-sectional view of a barrel of the lens module as shown in FIG. 1.

FIG. 3 is a cross-sectional view of a first lens element of the lens module as shown in FIG. 1.

FIG. 4 is a cross-sectional view of a second lens element of the lens module as shown in FIG. 1.

FIG. 5 is a cross-sectional view of a lens module in accordance with a second exemplary embodiment of the present disclosure.

FIG. 6 is a cross-sectional view of a barrel of the lens module as shown in FIG. 5.

FIG. 7 is a cross-sectional view of a first lens element of the lens module as shown in FIG. 5.

FIG. 8 is a cross-sectional view of a second lens element of the lens module as shown in FIG. 5.

FIG. 9 is a cross-sectional view of a lens module in accordance with a third exemplary embodiment of the present disclosure.

FIG. 10 is a cross-sectional view of a barrel of the lens module as shown in FIG. 9.

FIG. 11 is a bottom view of a first lens element of the lens module as shown in FIG. 10.

FIG. 12 is a cross-sectional view of a second lens element of the lens module as shown in FIG. 10.

FIG. 13 is a bottom view of the first lens element of the lens module as shown in FIG. 11.

FIG. 14 is a vertical view of the second lens element of the lens module as shown in FIG. 12.

Many aspects of the embodiments can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE EXEMPLARY EMBODIMENTS

Reference will now be made to describe the exemplary embodiments of the present invention in detail.

Referring to FIG. 1, a lens module 100 comprises a barrel 101, and a lens group 103 disposed in and connecting with the barrel 10.

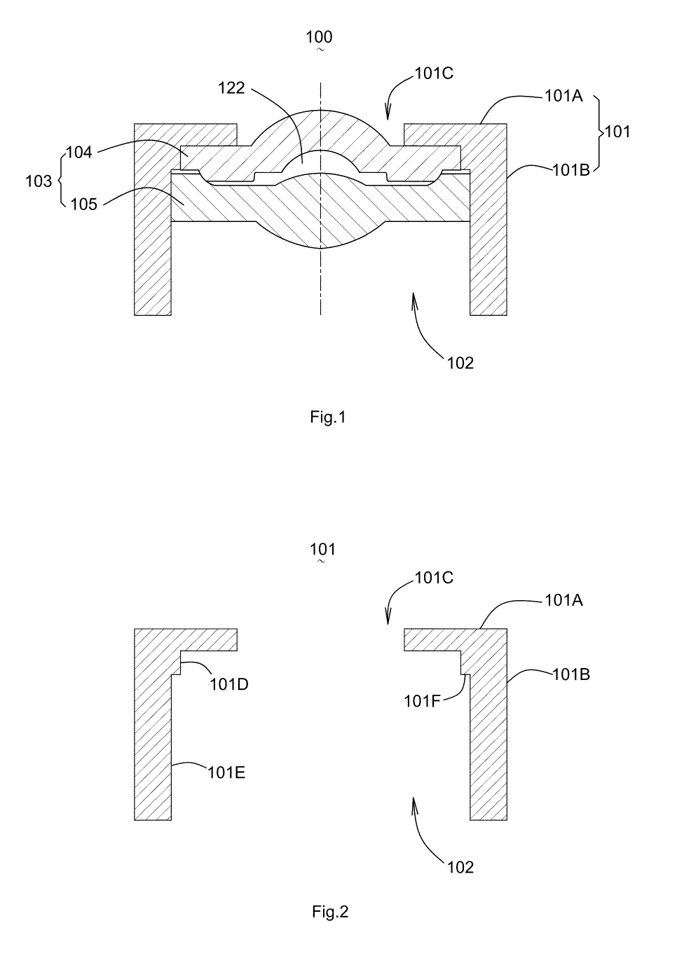

The barrel 101 has a first sidewall 101A, a light hole 101C formed in the center of the first sidewall 101A, and a second sidewall 101B extending from the first sidewall 101A along a direction perpendicular to the first sidewall 101A. The first sidewall 101A and the second sidewall 101B unite to form a receiving room 102, and the light hole 101C communicates with the receiving room 102. Referring to FIG. 2, the second sidewall 101B has a first engaging surface 101D, an extending surface 101F perpendicularly extending from the first engaging surface 101D, and a second engaging surface 101E perpendicularly extending from the extending surface 101F. By virtue of the extending surface 101F, an inner diameter of the first engaging surface 101D is smaller than an inner diameter of the second engaging surface 101E. In another word, the second engaging surface 101E is farther from an optic axis of the barrel 101 than the first engaging surface 101D.

The lens group 103 comprises a first lens element 104 and a second lens element 105 connecting with the first lens element 104. The first lens element 104 has a first optical axis 106 and the second lens element 105 has a second optical axis 121.

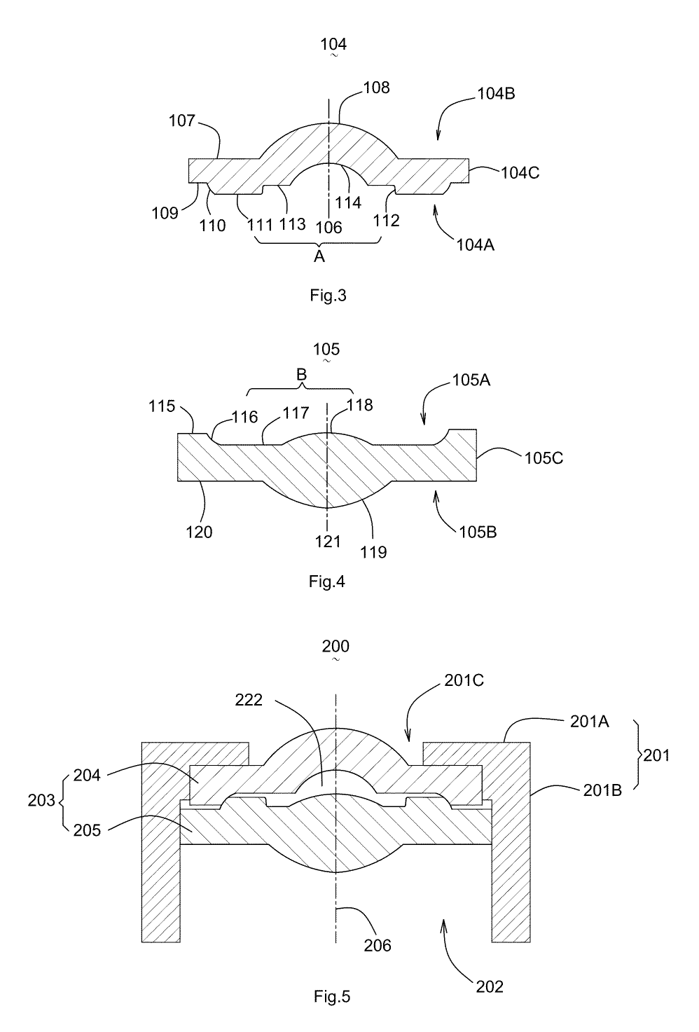

Referring to FIG. 3, the first lens element 104 has a first surface 104A opposite to the second lens element 105, a second surface 104B opposite to the first surface 104A and a side surface 104C connecting with the first surface 104A and the second surface 104B. The side surface 104C engages with the first engaging surface 101D. The first surface 104A has a first portion A arranged at the middle of the first surface 104A and centered about the first optical axis 106, a first arc surface 110 extending from the periphery of the first portion A and a second portion 109 extending from the first arc surface 110 and away from the first portion A. The first portion A comprises a first optical surface 114 arranged at the middle of the first surface 104A and centered about the first optical axis 106, a first extending surface 113 extending from the periphery of the first optical surface 114 and away from the first optical axis 106, a connecting surface 112 bended along from and extending from the periphery of the first extending surface 113, and a second extending surface 111 extending from the periphery of the connecting surface 112 and away from the first optical axis 106. The second surface 104B has a second optical surface 108 at the center of the second surface 104B and centered about the first optical axis 106, and a third extending surface 107 extending from the periphery of the second optical surface 108 and engaging with the surface of the first sidewall 101A facing the receiving room 102. The third extending surface 107 engaging with the first sidewall 101A and the side surface 104C engaging with the first engaging surface 101D make the lens module 100 have a first matching precision. The first matching precision is used for ensuring the barrel 101 is coaxial with the first lens element 104.

Referring to FIG. 4, the second lens element 105 has an upper surface 105A near the first lens element 104, a lower surface 105B opposite to the upper surface 105A and a periphery surface 105C connecting with the upper surface 105A and the lower surface 105B. The periphery surface 105C engages with the second engaging surface 101E. The upper surface 105A has a third portion B arranged at/at the middle of the upper surface 105A and centered about the second optical axis 121, a second arc surface 116 extending from the periphery of the third portion B and engaging with the first arc surface 110, and a fourth portion 115 extending from the periphery of the second arc surface 116 and away from the third portion B. The fourth portion 115 keeps a distance from the second portion 109. The third portion B comprises a third optical surface 118 arranged at/at the middle of the upper surface 105A and centered about the second optical axis 121, and a first bearing surface 117 extending from the periphery of the third optical surface 118. The second arc surface 116 engages with the first arc surface 110 for forming a second matching precision of the lens module 100. The lower surface 105B has a fourth optical surface 119 at the center of the lower surface 105B and centered about the second optical axis 121, and a second bearing surface 120 extending from the periphery of the fourth optical surface 119. The second matching precision is used for ensuring the first lens element 104 is coaxial with the second lens element 105, that is, the first optical axis 106 is coincide with the second optical axis 121.

In the first embodiment, the first arc surface 111 and the second arc surface 117 are configured to be a part of a circle. Specifically, the first arc surface 111 is a convex arc surface, and the second arc surface 117 is correspondingly a concave arc surface. Furthermore, the lens module 100 further has an air interval 122 formed by the first portion A and the third portion B. The air interval 122 is used for receiving a light filter. The thickness of the light filter should be smaller than that of the air interval 122, thereby the thickness tolerance of the light filter will not impact the matching precision between the first lens element 104 and the second lens element 105. Besides, the distance between the first portion A and the third portion B, and the distance between the second portion 109 and the fourth portion 115 ensure that the concentricity of the lens group 103 is determined solely by the engaging structure between the first arc surface 110 and the second arc surface 116, that is, the axiality tolerance of the barrel 101 does not impact the concentricity of the lens group 103.

The engaging structure between the first lens element 104 and the second lens element 105 ensures the first optical axis 106 and the second optical axis 121 are coincide with each other, and the engaging structures between the first lens element 104 and the barrel 101 ensure the center of the light hole 104C is located on the common optical axis of the first lens element 104 and the second lens element 105, thereby the concentricity between the barrel 101 and the lens group 103 is ensured.

FIG. 5 illustrates the cross-sectional view of the second embodiment of the lens module according with the present disclosure. A lens module 200 comprises a barrel 201 and a lens group 203 disposed in and connecting with the barrel 201.

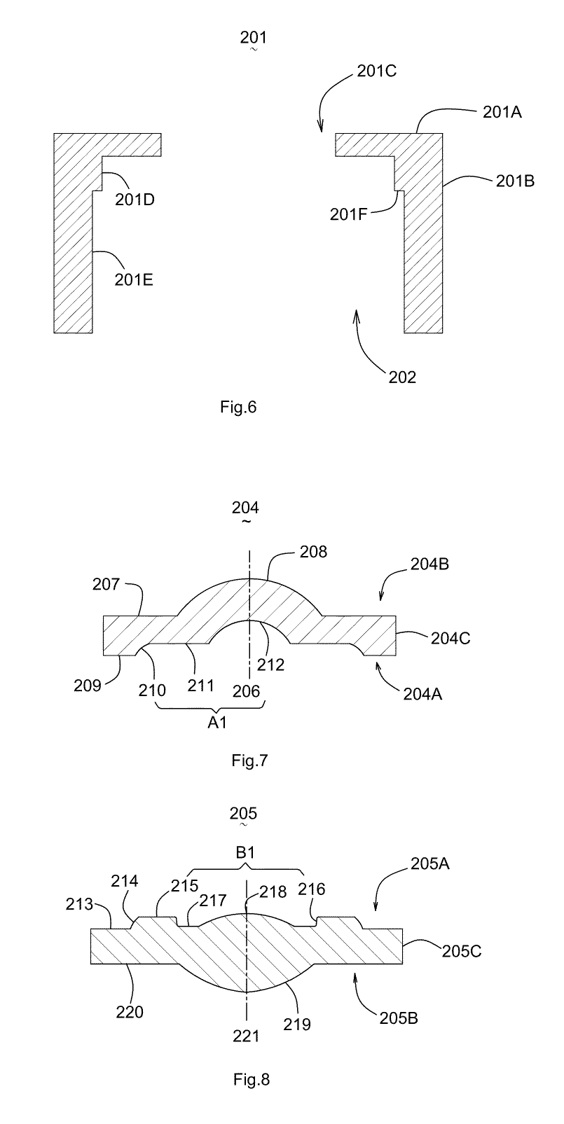

The barrel 201 has a first sidewall 201A, a light hole 201C formed in the center of the first sidewall 201A, and a second sidewall 201B extending from the first sidewall along a direction perpendicular to the first sidewall 201A. The first sidewall 201A and the second sidewall 201B unite to form a receiving room 202, and the light hole 201C communicates with the receiving room 202. Referring to FIG. 6, the second sidewall 201B has a first engaging surface 201D, an extending surface 201F perpendicularly extending from the first engaging surface 201D, and a second engaging surface 201E perpendicularly extending from the extending surface 201F. By virtue of the extending surface 201F, an inner diameter of the first engaging surface 201D is smaller than an inner diameter of the second engaging surface 201E. In another word, the second engaging surface 201E is farther from an optic axis of the barrel 201 than the first engaging surface 201D.

The lens group 203 comprises a first lens element 204 and a second lens element 205 connecting with the first lens element 204. The first lens element 204 has a first optical axis 206 and the second lens element 205 has a second optical axis 221.

Referring to FIG. 7, the first lens element 204 has a first surface 204A opposite to the second lens element 205, a second surface 204B opposite to the first surface 204A and a side surface 204C connecting with the first surface 204A and the second surface 204B. The side surface 204C engages with the first engaging surface 201D. The first surface 204A has a first portion A1 arranged at the middle of the first surface, a first arc surface 210 extending from the periphery of the first portion A1 and a second portion 209 extending from the periphery of the first arc surface. The first portion A1 comprises a first optical surface 212 arranged at the middle of the first surface 204A and centered about the first optical axis 206, and a first extending surface 211 extending from the periphery of the first optical surface 212. The second surface 204B has a second optical surface 208 arranged at the middle of the second surface 204B and centered about the first optical axis 206, and a second extending surface 207 extending from the periphery of the second optical surface 208 and engaging with the first sidewall 201A. The second extending surface 207 engaging with the first sidewall 201A and the side surface 204C engaging with the first engaging surface 201D make the lens module 200 have a first matching precision. The first matching precision is used for ensuring the barrel 201 is coaxial with the first lens element 204.

Referring to FIG. 7, the second lens element 205 has an upper surface 205A near the first lens element 204, a lower surface 205B opposite to the upper surface 205A and a periphery surface 205C connecting with the upper surface 205A and the lower surface 205B. The periphery surface 205C engages with the second engaging surface 201E. The upper surface 205A has a third portion B1 arranged at the middle of the upper surface 205A, a second arc surface 214 extending from the periphery of the third portion B1 and engaging with the first arc surface 210, and a fourth portion 213 extending from the periphery of the second arc surface 214. The fourth portion 213 keeps a distance from the second portion 209. The third portion B1 comprises a third optical surface 218 arranged at the middle of the upper surface 205A and centered about the second optical axis 221, a first bearing surface 217 extending from the periphery of the third optical surface 218, a transition surface 216 bended from and extending from the periphery of the first bearing surface 217, and a second bearing surface 215 extending from the periphery of the transition surface 216. The second arc surface 214 engages with the first arc surface 210 for forming a second matching precision of the lens module 200. The lower surface 205B has a fourth optical surface 219 arranged at the middle of the lower surface 205B and centered about the second optical axis 221, and a third bearing surface 220 extending from the periphery of the fourth optical surface 219. The second matching precision is used for ensuring the first lens element 204 is coaxial with the second lens element 205, that is, the first optical axis 206 is coincide with the second optical axis 221.

In the second embodiment, the first arc surface 210 and the second arc surface 214 are configured to be a part of a circle. Specifically, the first arc surface 210 is a concave arc surface, the second arc surface 214 is correspondingly a convex arc surface.

Furthermore, the lens module 200 further has an air interval 222 formed by the first portion A1 and the third portion B1. The air interval is used for receiving a light filter. The thickness of the light filter should be smaller than that of the air interval 222, thereby, the thickness tolerance of the light filter will not impact the matching precision between the first lens element 204 and the second lens element 205. Besides, the distance between the first portion A1 and the third portion B1, and the distance between the second portion 209 and the fourth portion 213 ensure the concentricity of the lens group 203 is only decided by the engaging structure between the first arc surface 209 and the second arc surface 217, that is, the axiality tolerance of the barrel 201 does not impact the concentricity of the lens group 203.

The engaging structure between the first lens element 204 and the second lens element 205 ensures the first optical axis 206 and the second optical axis 221 are coincide with each other, and the engaging structures between the first element 204 and the barrel 201 ensure the center of the light hole 204C is located on the common optical axis of the first lens element 204 and the second lens element 205, thereby the concentricity between the barrel 201 and the lens group 203 is ensured.

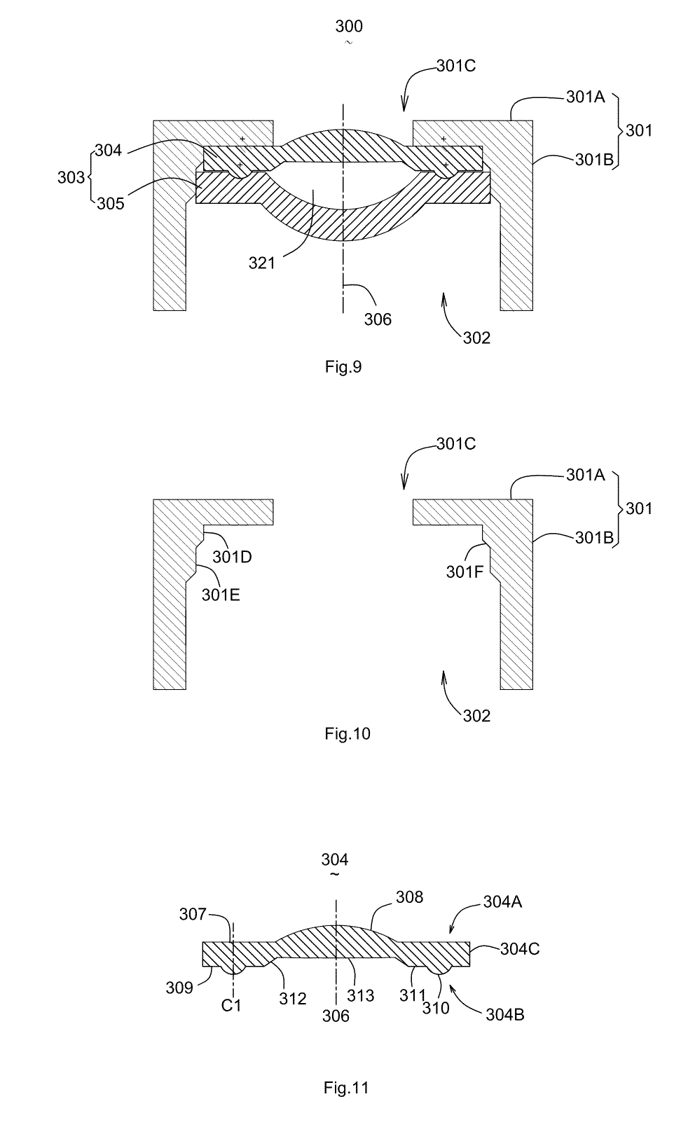

FIG. 9 illustrates the cross-sectional view of the third embodiment of the lens module according with the present disclosure. A lens module 300 comprises a barrel 301 and a lens group 303 disposed in and connecting with the barrel 301.

The barrel 301 has a first sidewall 301A, a light hole 301C at the center of the first sidewall 301A, and a second sidewall 301B extending from the first sidewall along a direction perpendicular to the first sidewall 301A. The first sidewall 301A and the second sidewall 301B unite to form a receiving room 302, and the light hole 301C communicates with the receiving room 302. Referring to FIG. 10, the second sidewall 301B has a first engaging surface 301D, an extending surface 301F extending from the first engaging surface 301D and bended along a direction far away from the line crossing the center of the light hole 301C, and a second engaging surface 301E bended along and extending from the extending surface 301F.

The lens group 303 comprises a first lens element 304 and a second lens element 305 connecting with the first lens element 304. The first lens element 304 has a first optical axis 306 and the second lens element 305 has a second optical axis 320.

Referring to FIG. 11, the first lens element 304 has a first surface 304A opposite to the second lens element 305, a second surface 304B opposite to the first surface 304A and a side surface 304C connecting with the first surface 304A and the second surface 304B. The side surface 304C engages with the first engaging surface 301D. The first surface 304A has a first portion A2 arranged at the middle of the first surface 304A, a first arc surface 310 extending from the periphery of the first portion A2 and a second portion 309 extending from the periphery of the first arc surface 310. The first portion A2 comprises a first optical surface 313 arranged at the middle of the first surface 304A and centered about the first optical axis 306, a transition surface 312 bended from and extending from the periphery of the first optical surface 307, and a first extending surface 311 extending from the periphery of the transition surface 312. The second surface 304B has a second optical surface 308 arranged at the middle of the second surface 304B and centered about the first optical axis 306, and a second extending surface 307 extending from the periphery of the second optical surface 308 and engaging with the first sidewall 301A. The second extending surface 307 engaging with the first sidewall 301A and the side surface 304C engaging with the first engaging surface 301D make the lens module 300 have a first matching precision. The first matching precision is used for ensuring the barrel 301 is coaxial with the first lens element 304.

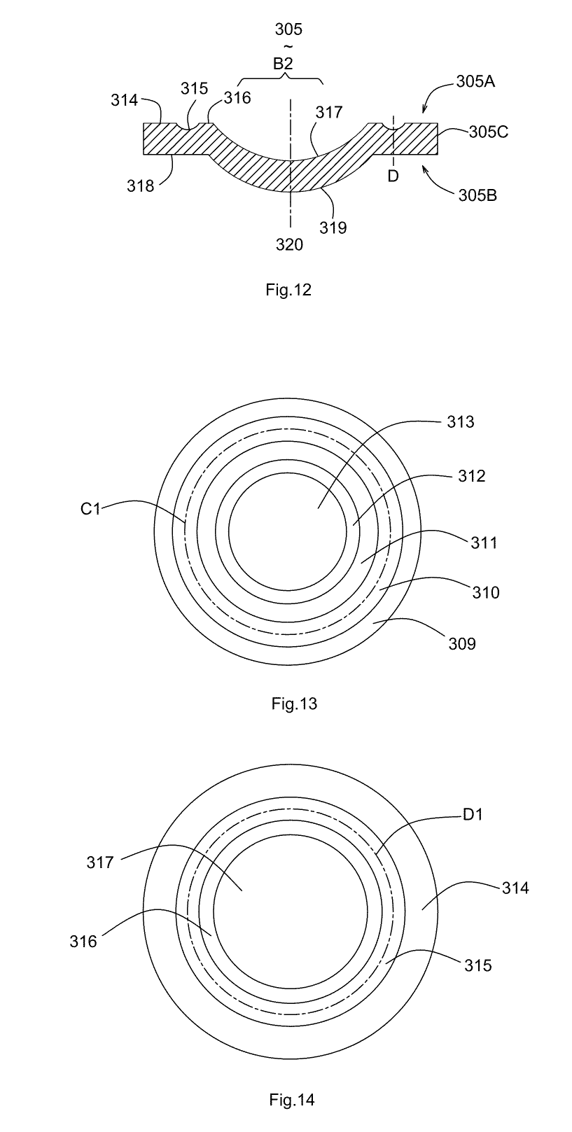

Referring to FIG. 12, the second lens element 305 has an upper surface 305A near the first lens element 304, a lower surface 305B opposite to the upper surface 305A and a periphery surface 305C connecting with the upper surface 305A and the lower surface 305B. The periphery surface 305C engages with the second engaging surface 301E. The upper surface 305A has a third portion B2 arranged at the middle of the upper surface 305A, a second arc surface 315 extending from the periphery of the third portion B2 and engaging with the first arc surface 310, and a fourth portion 314 extending from the periphery of the second arc surface 315. The fourth portion 314 keeps a distance from the second portion 309. The third portion B2 comprises a third optical surface 317 arranged at the middle of the upper surface 305A and centered about the second optical axis 320, and a first bearing surface 316 extending from the periphery of the third optical surface 314. The second arc surface 315 engages with the first arc surface 310 for forming a second matching precision of the lens module 300. The lower surface 305B has a fourth optical surface 319 arranged at the middle of the lower surface 305B and centered about the second optical axis 320, and a second bearing surface 318 extending from the periphery of the fourth optical surface 319. The second matching precision is used for ensuring the first lens element 304 is coaxial with the second lens element 305, that is, the first optical axis 306 is coincide with the second optical axis 320.

In this embodiment, the first arc surface 310 has a continuous line C that furthest from the second surface 304B. Referring to FIG. 13, the continuous line C is formed by the lowest points of the first arc surface 310, and the continuous line C is a closed circle. Referring back to FIG. 11, take the cross-sectional view of the first arc surface 310 on the left for example, the cross-sectional view of the first arc surface 310 on the left is symmetrical about line C. Referring to FIG. 14, the second arc surface 315 has a continuous line D that furthest from the upper surface 305A. The continuous line D is formed by the lowest points on the second arc surface 315, and the continuous line D is a circle. Referring back to FIG. 12, take the cross-sectional view of the second arc surface 315 on the right for example, the cross-sectional view of the second arc surface 316 on the right is symmetrical about the line D. Optionally, the first arc surface 310 and the second arc surface 315 could be a discontinuous arc surface.

Furthermore, the lens module 300 further has an air interval 321 formed by the first portion A2 and the third portion B2. The air interval 321 is used for receiving a light filter. The thickness of the light filter should be smaller than that of the air interval 321, thereby, the thickness tolerance of the light filter will not impact the matching precision between the first lens element 304 and the second lens element 305. Besides, the distance between the first portion A2 and the third portion B2, and the distance between the second portion 309 and the fourth portion 314 ensure the concentricity of the lens group 303 is only decided by the engaging structure between the first arc surface 310 and the second arc surface 315, that is, the axiality tolerance of the barrel 301 does not impact the concentricity of the lens group 303.

The engaging structure between the first lens element 304 and the second lens element 305 ensures the first optical axis 306 and the second optical axis 320 are coincide with each other, and the engaging structures between the first element 304 and the barrel 301 ensure the center of the light hole 304C is located on the common optical axis of the first lens element 304 and the second lens element 305, thereby the concentricity between the barrel 301 and the lens group 303 is ensured.

While the present disclosure has been described with reference to the specific embodiment, the description of the disclosure is illustrative and is not to be construed as limiting the disclosure. Various of modifications to the present disclosure can be made to the exemplary embodiment by those skilled in the art without departing from the true spirit and scope of the disclosure as defined by the appended claims.

What is claimed is:

1. A lens module, comprising:
a barrel having a first sidewall, a light hole in a center of the first sidewall, a second sidewall extending from the first sidewall and a receiving room formed by the first sidewall and the second sidewall;
a first lens element disposed in the receiving room and connecting with the barrel for making the lens module have a first matching precision, the first lens having a first optical axis, a first surface, a second surface opposite to the first surface and a side surface connecting with the first surface and the second surface, the side surface engaging with the second sidewall, the first surface having a first portion arranged at the middle of the first surface, a first arc surface extending from a periphery of the first portion and a second portion extending from a periphery of the first arc surface;
a second lens element disposed in the receiving room and connecting with the first lens element for making the lens module have a second matching precision, the second lens element having a second optical axis, an upper surface near the first lens element, a lower surface opposite to the upper surface and a periphery surface connecting with the upper surface and the lower surface, the periphery surface engaging with the second sidewall, the upper surface having a third portion arranged at the middle of the upper surface and centered about the second optical axis, a second arc surface extending from a periphery of the third portion and engaging with the first arc surface, and a fourth portion extending from a periphery of the second arc surface;
the first portion keeping a predetermined distance from the third portion and the second portion keeping a predetermined distance from the fourth portion, the second matching precision making the first optical axis and the second optical axis coincide with each other and the first matching precision making the center of the light hole be located on the optical axis of the first lens element and the second lens element.

2. The lens module as described in claim 1, wherein the first portion comprises a first optical surface arranged at the middle of the first surface and centered about the first optical axis, a first extending surface extending from a periphery of the first optical surface, a connecting surface extending from a periphery of the first extending surface, and a second extending surface extending from a periphery of the connecting surface.

3. The lens module as described in claim 2, wherein, the second surface has a second optical surface arranged at the middle of the second surface and centered about the first optical axis, and a third extending surface extending from a periphery of the second optical surface and engaging with the first sidewall.

4. The lens module as described in claim 3, wherein the third portion comprising a third optical surface arranged at the middle of the upper surface and centered about the second optical axis, and a first bearing surface extending from the third optical surface.

5. The lens module as described in claim 1, wherein the first portion comprises a first optical surface arranged at the middle of the first surface and centered about the optical axis and a first extending surface extending from a periphery of the first optical surface.

6. The lens module as described in claim 5, wherein the second surface comprises a second optical surface arranged at the middle of the second surface and centered about the first optical axis, and a second extending surface extending from a periphery of the second optical surface and engaging with the first sidewall.

7. The lens module as described in claim 6, wherein the third portion comprises a third optical surface arranged at the middle of the upper surface and centered about the second optical axis, a first bearing surface extending from a periphery of the third optical surface, a transition surface extending from a periphery of the first bearing surface, and a second bearing surface extending from a periphery of the transition surface.

8. The lens module as described in claim 7, wherein the first lens elements further comprises a side surface connecting with the first surface and the second surface, the side surface engages with the second sidewall, the second lens elements further comprises a periphery surface connecting with the upper surface and the lower surface, the periphery surface keeps a distance with the second sidewall.

9. The lens module as described in claim 1, wherein the first portion comprises a first optical surface arranged at the middle of the first surface and centered about the first optical axis, a transition surface extending from a periphery of the first optical surface, and a first extending surface extending from a periphery of the transition surface.

10. The lens module as described in claim 9, wherein the second surface has a second optical surface arranged at the middle of the second surface and centered about the optical axis, and a second extending surface extending from a periphery of the second optical surface and engaging with the first sidewall.

11. The lens module as described in claim 10, wherein the third portion comprising a third optical surface arranged at the middle of the upper surface and centered about the second optical axis, and a first bearing surface extending from the third optical surface.

12. The lens module as described in claim 1 further comprising a light filter disposed between the first portion and the third portion.
